(19) United States
(12) Patent Application Publication
(10) Pub. No.: US 2004/0178337 A1
(43) Pub. Date: Sep. 16, 2004

(54) Neutron detector for downhole use

(75) Inventors: Philip L. Kurkoski, Houston, TX (US); Volker Krueger, Celle (DE); Cornelis Huiszoon, Houston, TX (US); Eric B. Molz, Houston, TX (US); Pingjun Guo, Pearland, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated, Houston, TX

(21) Appl. No.: 10/386,344

(22) Filed: Mar. 11, 2003

(51) Int. Cl. G01V 5/10

(52) U.S. Cl. 250/269.4

(57) ABSTRACT

A tool for measuring formation properties in situ. The tool includes a solid state neutron detector and a neutron source disposed on a drill string or wireline. The detector includes a boron carbon surface deposited on a substrate, and the surface can be multi-planar or curved for allowing sensitivity in more than one direction.

### BACKGROUND OF THE INVENTION

1. Field of the Invention

This invention generally relates to the testing of underground formations or reservoirs, and more particularly to a downhole tool having a solid state neutron detector and a method of using same.

2. Description of the Related Art

While drilling a well for commercial development of hydrocarbon reserves, several subterranean reservoirs and formations are encountered. In order to discover information about the formations, such as whether the reservoirs contain hydrocarbons, logging devices are used to evaluate several characteristics of these reservoirs. Historically, such logging devices have been incorporated in a sonde, which is conveyed into the borehole on a wireline. During drilling operations, the drill string is usually tripped and the wireline is lowered into the borehole for logging. This is a costly method of logging a well during drilling, because the drilling operation must be stopped for the logging operation.

Logging-while-drilling systems (hereinafter LWD) have been developed that contain resistivity, nuclear and other logging devices which can constantly monitor formation and reservoir characteristics during drilling of well boreholes. The LWD systems can generate data that includes information about the presence of hydrocarbon presence, saturation levels, and formation porosity. Telemetry systems have been developed for use with the MWD systems to transmit the data to the surface. A common telemetry method is the mud-pulsed system, an example of which is found in U.S. Pat. No. 4,733,233. MWD systems provide real time analysis of the subterranean reservoirs.

Neutron porosity measurements are valuable measurements made using standard wireline-conveyed or logging while drilling (LWD) technology. A typical tool for making these measurements usually has a chemical source, multiple neutron detectors and sometimes shielding between the source and neutron detectors.

In operation neutrons of interest are emitted from the source, travel through the formation, scattering and losing their energy, and are absorbed by the detectors. When emitted neutrons travel through the formation, the most likely event (scattering event) is an interaction with water existing in the formation. During scattering, which is a multiple interaction event, the neutron may lose most of its kinetic energy and become “thermalized” (<100 KeV) or may be stopped altogether. The neutron detector absorbs these low-energy thermal neutrons, and circuitry converts the absorbed neutrons into a count parameter. The count rate of thermal neutrons (in counts per second) determines the water-filled porosity of the formation.

Some neutrons emitted from the source take other paths such as through the tool body and through drilling mud without entering the formation. When these neutrons are absorbed by the detectors, the neutron counts and subsequent ratio are adversely affected making the porosity determination somewhat unreliable. Shielding in the typical tool is an attempt to minimize these unwanted counts.

Currently, two known tools are used in detecting thermal neutrons for LWD and wireline applications. One typical tool is known as a helium tube and the other is known as a scintillator. The scintillator uses Li⁶ glass, which is basically standard glass silicate (SiO₂) with a certain content of lithium oxide (LiO₂). The glass can be cut into any shape and size desired. The Li⁶ glass scintillator has a large neutron cross section, and the result of the reaction with an incoming neutron is a pulse of visible photons. The resultant photons are then converted to a current pulse using a photomultiplier tube (PMT) optically coupled to the Li⁶ glass.

Typical helium tube detectors use He³ gas. The He³ gas also has a large cross section for absorbing neutrons (N) with the following reaction:

He³+N→H³(0.191 MeV)+P(0.573 MeV)

The result of the interaction is two charged particles: a triton (H³) and a proton (P). Typically the He³ gas is contained in a cylindrical metal chamber. A fine metal wire is run directly through the chamber from one end to the other. The wire is electrically insulated from the metal chamber and held at a large voltage from that of the metal chamber. When a neutron is absorbed, the resulting triton and proton are accelerated in opposite directions in response to the large electric field. An avalanche of extra charge is created as triton and proton scatter from other atoms on the path to their respective electrodes. The result is a short duration current pulse like that of a photomultiplier tube but of a much lower magnitude.

Problems exist with either typical detector arrangement. The Li⁶ glass scintillator requires a photomultiplier tube. The performance and useful life of a standard high temperature PMT degrades quickly above 125° C. The size of internal noise can become quite close to that of a neutron pulse. This is further exacerbated by the fact that Li⁶ glass has low light output in comparison to other scintillators. This technology is marginal for 150° C. use, and the technology is unusable at higher temperatures.

Helium tubes do not have the same problems as with the Li⁶ detectors. There is no need for a PMT and the inert gas is stable well above 150° C. However, the helium-based detector suffers from other problems. The chamber/wire combination is prone to failure. Moreover, when subjected to a drilling vibration environment, the metal wire tends to move with respect to the metal chamber. Wire movement results in a change in the voltage potential across the electrodes causing so-called vibration noise. This vibration noise may be as large as a neutron pulse, thus making the count inaccurate.

Helium and lithium detectors both suffer from space limitations in the downhole environment. And either detector can be adversely affected by neutrons traveling via non-formation paths such as through the drilling fluid or the tool body.

### SUMMARY OF THE INVENTION

The present invention addresses some of the drawbacks discussed above by providing a solid state neutron detector adapted for downhole use.

In one embodiment, an apparatus for determining a parameter of interest in an underground formation traversed by a borehole comprises a work string conveyed into the borehole. The work string might be a drill string or a wireline, and the apparatus includes a neutron source for irradiating the formation with neutrons. A solid state neutron detector in the work string has a detection surface oriented for capturing transmitted neutrons, the captured neutrons being indicative of the parameter of interest.

In one aspect the detection surface is a curved surface. In another aspect of the present invention the detection surface is a planar surface. While in another aspect the detection surface includes a plurality of planar surfaces.

In another aspect of the present invention, a method of determining neutron porosity of a formation in a downhole environment is provided. The method includes conveying a tool into a well borehole, irradiating the formation with neutrons using a neutron source housed in the tool, wherein at least some of the neutrons react with the formation and return to the tool as return neutrons, detecting the return electrons using a semiconductor neutron detector having a substrate and a detection surface, the semiconductor neutron detector providing current pulses indicative of return electrons captured by the detection surface. The method further includes processing the current pulses to determine neutron porosity of the formation.

In yet another aspect of the invention, a method of obtaining a parameter of interest in a well borehole comprises irradiating a formation surrounding the well borehole with neutrons using a neutron source, and capturing neutrons returning from the formation to the well borehole using a solid state detector having at least one non-planar neutron detection surface thereon.

Another method of the present invention includes testing an underground formation by conveying a tool through a well borehole traversing the formation, irradiating the formation with neutrons using a neutron source, detecting the emitted neutrons using a solid-state neutron detector, the detector having a detection surface oriented to receive neutrons emitted from the source, and determining a parameter of interest based at least in part on the received neutrons.

### BRIEF DESCRIPTION OF THE DRAWINGS

The novel features of this invention, as well as the invention itself, will be best understood from the attached drawings, taken along with the following description, in which similar reference characters refer to similar parts and wherein:

FIG. 1 is an elevation view of a typical well drilling system incorporating the present invention;

FIG. 2 shows a solid state neutron detector according to the present invention;

FIG. 3 is a cross section elevation view of a tool portion used in the system of FIG. 1;

FIG. 4A is a cross section top view of the tool portion of FIG. 3 to show one arrangement of the solid state detector;

FIGS. 4B-4C are alternative embodiments of the detector shown in FIG. 4A;

FIG. 5 is a cross section elevation view of another embodiment of the present invention having axial and radial neutron detectors.

FIG. 6 is a cross section top view of the tool portion in FIG. 5 to show the monitor detector;

FIG. 7 is another embodiment of the tool portion with curved detectors and an alternative source location;

FIGS. 8A-B show alternative detector arrangements to use on the tool portion shown in FIG. 7;

FIG. 9 is a wireline embodiment of the present invention;

FIG. 10 is a cross section elevation view of a tool portion used in the system of FIG. 9;

FIG. 11 is a cross section top view of the tool portion of FIG. 10 to show an arrangement of the solid state detector;

FIGS. 12 and 13 show another wireline embodiment of the present invention using a detector having a substantially circular cross section;

FIGS. 14-16 show another wireline embodiment of the present invention having multiple detectors with semi-circular cross section arranged about the tool; and

FIGS. 17A-17B show stacked and orthogonal sensor elements according to the present invention.

### DESCRIPTION OF PREFERRED EMBODIMENTS

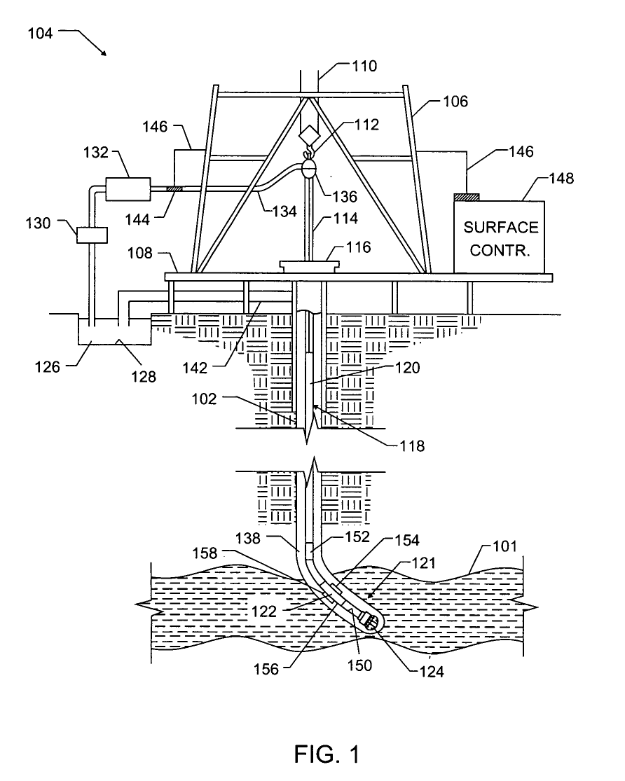

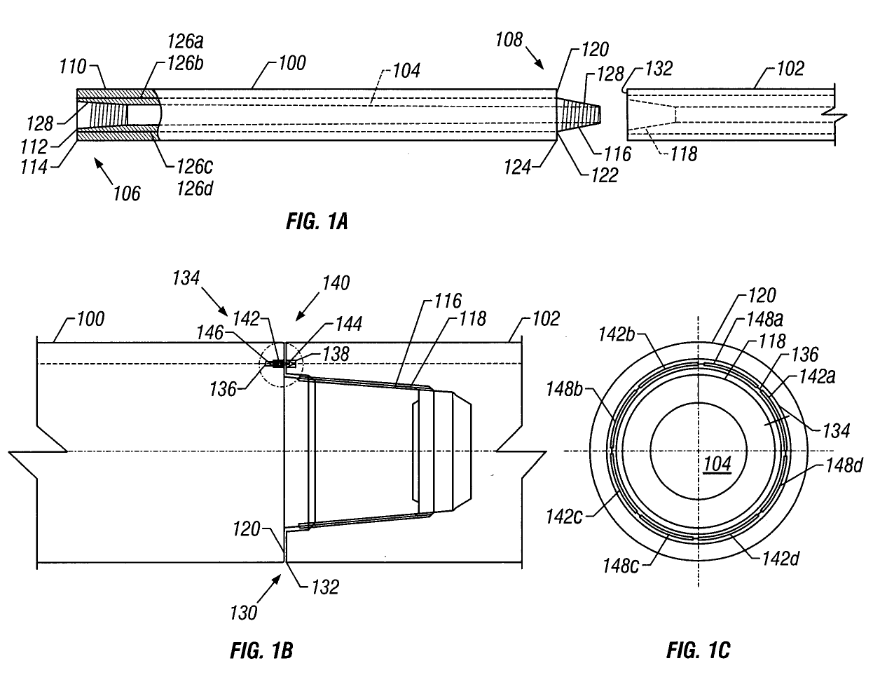

FIG. 1 is an elevation view of a simultaneous drilling and logging system that incorporates an embodiment of the present invention. A well borehole 102 is drilled into the earth under control of surface equipment including a rotary drilling rig 104. In accordance with a conventional arrangement, rig 104 includes a derrick 106, derrick floor 108, draw works 110, hook 112, kelly joint 114, rotary table 116, and drill string 118. The drill string 118 includes drill pipe 120 secured to the lower end of the kelly joint 114 and to the upper end of a section comprising a plurality of drill collars. The drill collars include not separately shown drill collars such as an upper drill collar, an intermediate sub drill collar, and a lower drill collar bottom hole assembly (BHA) 121 immediately below the intermediate sub. The lower end of the BHA 121 carries a downhole tool 122 of the present invention and a drill bit 124.

Drilling fluid 126 is circulated from a mud pit 128 through a mud pump 130, past a desurger 132, through a mud supply line 134, and into a swivel 136. The drilling fluid 126 flows down through the kelly joint 114 and a longitudinal central bore in the drill string, and through jets (not shown) in the lower face of the drill bit. Return fluid 138 containing drilling mud, cuttings and formation fluid flows back up through the annular space between the outer surface of the drill string and the inner surface of the borehole to be circulated to the surface where it is returned to the mud pit through a mud return line 142. A shaker screen (not shown) separates formation cuttings from the drilling mud before the mud is returned to the mud pit.

The system in FIG. 1 may use any conventional telemetry methods and devices for communication between the surface and downhole components. In the embodiment shown mud pulse telemetry techniques are used to communicate data from down hole to the surface during drilling operations. To receive data at the surface, there is a transducer 144 in mud supply line 132. This transducer generates electrical signals in response to drilling mud pressure variations, and a surface conductor 146 transmits the electrical signals to a surface controller 148.

If applicable, the drill string 118 can have a downhole drill motor 150 for rotating the drill bit 124. Incorporated in the drill string 118 above the drill bit 124 is the downhole tool 122 of the present invention, which will be described in greater detail hereinafter. A telemetry system 152 is located in a suitable location on the drill string 118 such as above the tool 122. The telemetry system 152 is used to receive commands from, and send data to, the surface via the mud-pulse telemetry described above.

The surface controller 148 preferably contains a computer, memory for storing data, data recorder and other peripherals. The surface controller 148 also responds to user commands entered through a suitable device, such as a keyboard.

In a preferred embodiment of the system of present invention, the BHA 121 contains various sensors and LWD devices to provide information about the formation, downhole drilling parameters and the mud motor. The downhole assembly 121 preferably is modular in construction, in that the various devices are interconnected sections so that the individual sections may be replaced when desired.

Still referring to FIG. 1, the BHA 121 also preferably contains sensors and devices in addition to the above-described sensors. Such devices include a device for measuring the formation resistivity near and/or in front of the drill bit, a gamma ray device for measuring the formation gamma ray intensity and devices for determining the inclination and azimuth of the drill string.

The BHA 121 of the present invention preferably includes a tool 122, which contains a nuclear formation porosity measuring device for providing information useful for evaluating and testing subsurface formations along the borehole 122.

The porosity measurement device preferably includes a solid state neutron detector, which will be described in detail later. In general, however, the tool 122 includes a neutron emission source and a solid state detector for measuring resulting thermal neutrons. In use, high energy neutrons are emitted into the surrounding formation. The tool 122 measures the reduced neutron flux due to interaction with hydrogen and atoms present in the formation. The emitted neutrons travel in a cloud that expands then reaches equilibrium. The solid state detectors are preferably orientated to measure components of the flux for a specific orientation. Alternatively, detectors are combined such that they simulate a 3-dimensional detector to measure flux in all directions. Signals from each component are combined to optimize or highlight a desired measurement.

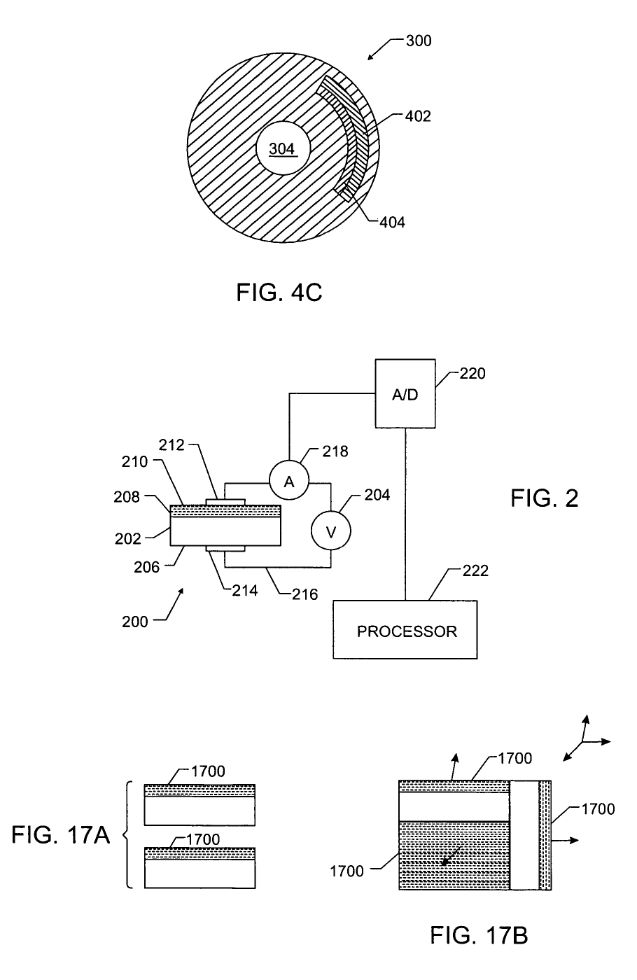

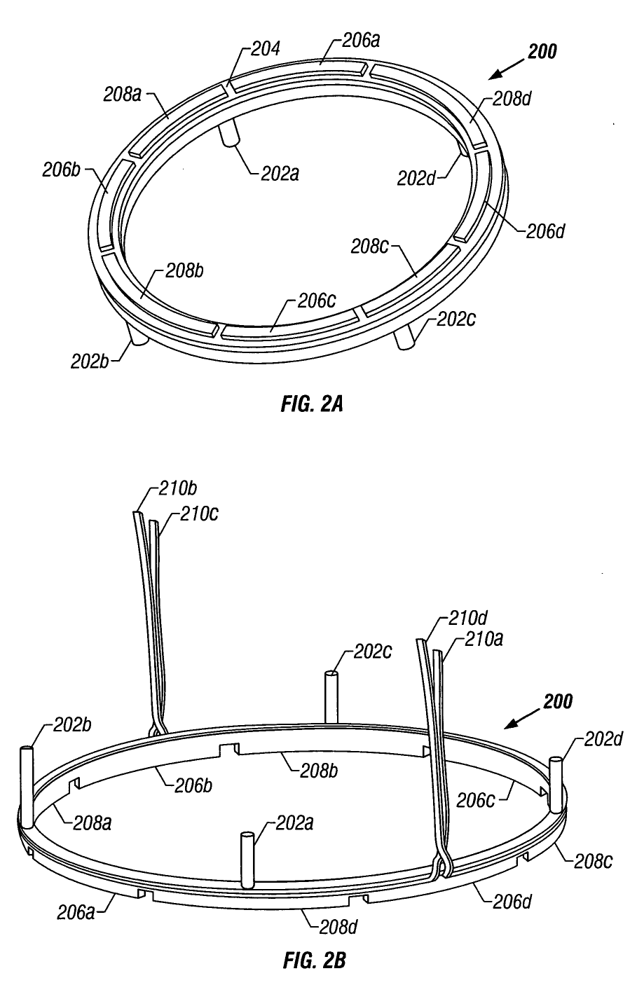

FIG. 2 illustrates a solid state neutron detector for use in the present invention. The detector 200 includes a sensing element 202 coupled to a biasing source 204. The sensing element 202 includes a substrate 206 with a layer 208 of material suitable for capturing neutrons, and which layer forms a detection surface 210 for the detector 200. The layer 208 is preferably a heavily doped layer of boron-carbon.

Electrodes 212 and 214 are respectively mounted on the substrate 206 and detection surface 210. The electrodes 212 and 214 are coupled to the biasing source 204 using an electrically conductive path 216. The path 216 can be metal traces on a printed circuit board, insulated wires or a combination of traces and wires.

Neutrons encountering the detection surface 210 are captured by the layer 208. A resultant energy transfer is then transformed by the element into a short duration reverse current pulse in the path 216. The current pulse can be detected by suitable peak detection circuitry indicated as an ammeter 218 disposed in the path 216. The current pulse is preferably converted to a digital signal using an analog to digital converter 220. The digital signal is then preferably processed in a processor to determine a neutron count rate.

In several alternative embodiments to be described in detail later, the present invention includes multiple detectors 200 in varied orientations or a detector having a single element 202, which includes a shaped surface to increase the surface area of the detection surface 210. In one embodiment, an axially-disposed element is oriented to enable a particular count of neutrons traveling in the tool body and/or in drilling fluid. In each of these alternative embodiments, the element or elements provide a current pulse as described above. These multiple current pulses are preferably converted to a digital signal and processed using one or more processors such as the processor 222. The processor 222 is preferably located downhole on the tool in the several LWD embodiments of the present invention. Although a surface processor can also be used when desired.

Referring still to FIG. 2, the sensor element is preferably fabricated using standard chemical vapor deposition techniques to deposit the layer 208 onto the substrate 206. The substrate is preferably a silicon substrate (Si111) and the layer 208 is preferably Boron-Carbon (B₅C). In this embodiment, the boron-carbide acts as a P-type material and the Si1111 acts as an N-type material to form a semiconductor detector.

Preferably single molecular sources of boron (B) and carbon (C) are chosen. A suitable substrate is chosen, such as the Si111 substrate, which is thin and smooth to yield a reasonable contact surface. The boron-carbide layer is then grown on the surface using known deposition techniques. With this sensing element and when assembled as the detector 200, the biasing source 204 preferably reverse biases the P-N semiconductor. In this configuration, only a small reverse current will flow.

The isotope boron10 (B¹⁰) is well known for its ability to absorb thermal neutrons. The boron-carbide crystal layer described above will have an operative amount of the B¹⁰, and either of two B¹⁰ interactions can occur:

B¹⁰+N→Li(0.84 MeV)+He⁴(1.47 MeV)+γ(0.48 MeV); or

B¹⁰+N→Li⁷(1.02 MeV)+He⁴(1.78 MeV).

In either interaction, two charged particles result; lithium (Li) and helium (He). The two charge carriers under the influence of the applied electric field (bias) move toward the electrodes 212, 214. In doing so, scattering from other molecules (e.g. water) liberates more electrons (or holes). As a result, a measurable back-biased current flows when a neutron is captured. And the detector circuitry 218, 220, and 222 process the current pulse to determine various parameters indicated by the captured neutrons. Various downhole tools according to the present invention use solid-state detectors according to FIG. 2 in several embodiments described below.

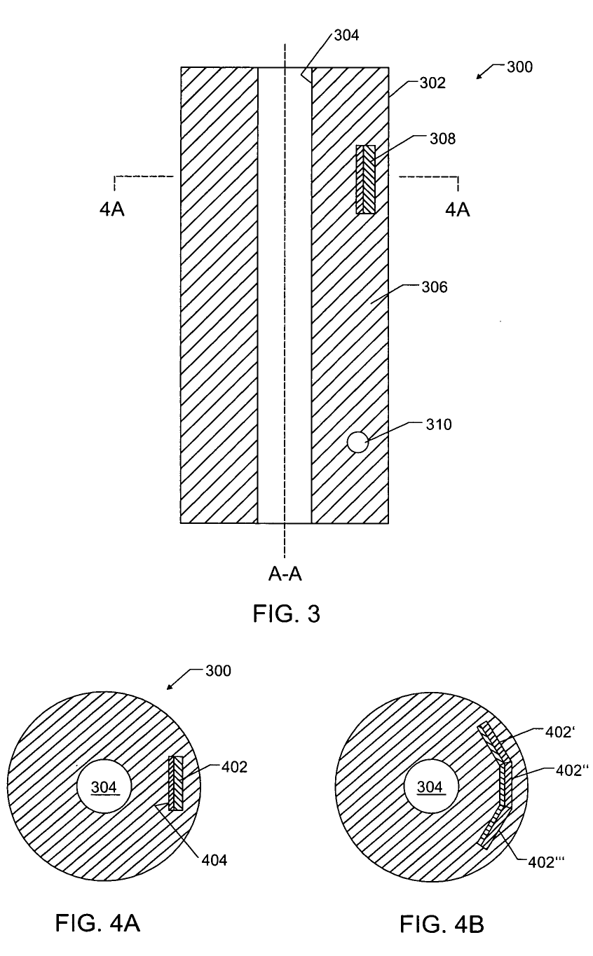

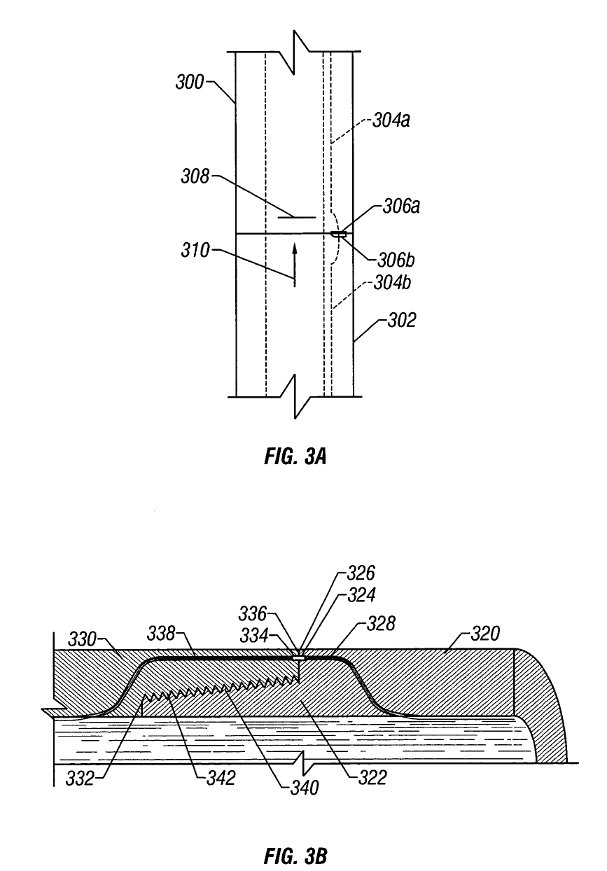

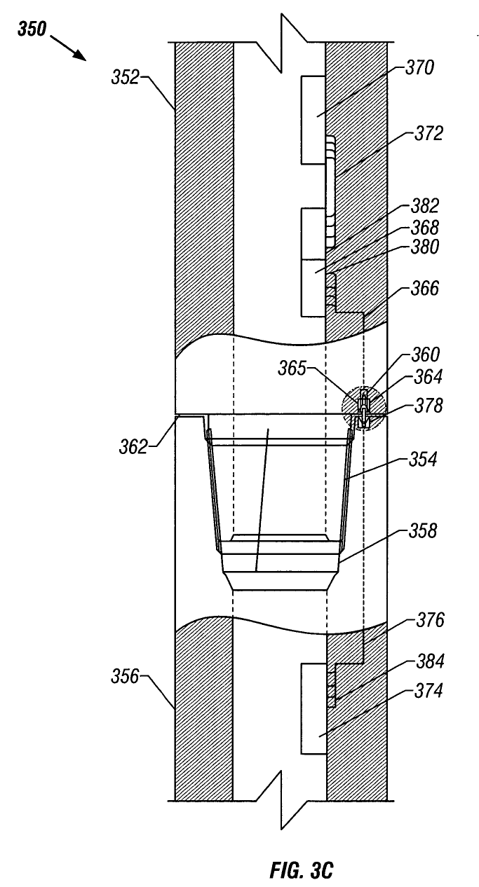

FIG. 3 illustrates an embodiment of the present invention for logging while drilling (LWD). Shown in cross section is a tool portion 300. The tool portion 300 is, for example, a drill collar or a bottom-hole assembly (BHA) 121 described above and shown in FIG. 1. The tool portion 300 preferably includes a cylindrical body 302 having a central bore 304 for allowing drilling fluid to flow through the tool. A neutron source 310 is disposed in the tool body 302, and one or more detectors 306 and 308 substantially similar to the detector 200 described above and shown in FIG. 2 are disposed in the tool body 302 for detecting neutrons emitted from the neutron source 310.

Shown is a dual-detector arrangement. A first detector (near detector) 306 is disposed in the tool body 302 axially displaced from the neutron source 310. Those skilled in the art would recognize the near detector as being useful in determining a total neutron count related to the neutrons emitted from the source 310. A second detector (far detector) 308 is disposed in the wall axially displaced from the first detector 306 and from the neutron source 310. Those skilled in the art would recognize the far detector as being useful in determining a count of neutrons that have traveled through the formation and thermalized by scattering events in the formation. For simplicity, conductive paths, detection circuitry, A/D conversion circuitry and processors are not shown here. These components, however, would be substantially similar to the like components described above and shown in FIG. 2.

Several alternative embodiments of the present invention can be described with reference to FIGS. 1 and 3. The tool portion 300 might include a non-rotating sleeve 156 to house the detectors 306 and 308. The tool portion can likewise include one or more extendable elements 154 such as extendable probes or extendable steering blades for housing the detectors 306 and 308 and to enable moving the detectors toward the borehole wall. The detectors might also be in a fixed stabilizer 158.

FIG. 4A is a top view in cross section to show one embodiment of the detector. The detector 308 is shown with a substantially planar detection surface 402 oriented outwardly with respect to the tool center and a substrate 404 oriented inwardly toward the central bore 304. In this embodiment, the boron-carbon layer is preferably manufactured to be relatively thick or comprise multiple layers to provide good capture as neutrons strike the planar sensing surface.

FIG. 4B shows an embodiment of the present invention having multiple planar detection surfaces 402′, 402″, and 402′″. The detection surfaces are arranged to provide multiple planes angularly displaced to provide more capture surface area. The embodiment of FIG. 4B can be manufactured from a single substrate or from several substrates bonded together as shown.

FIG. 4C shows an embodiment of a detector 308 having a detection surface 402 with a curved cross section. The sensing element of this embodiment is preferably manufactured by machining a single substrate 404 into a curved shape and depositing a detection layer on the machined substrate to form the detection surface 402. Such a curved surface provides a large detector surface area for capturing neutrons.

FIG. 5 is a cross section elevation view of another embodiment of the present invention having axial and radial neutron detectors. Shown is a tool portion 500 substantially similar to the portion 300 described above and shown in FIG. 3. The embodiment of FIG. 5 illustrates a neutron detector oriented axially in the tool body to function as a monitor detector 502. The monitor detector 502 is substantially similar to the detector 200 described above and shown in FIG. 2. The monitor detector includes a detection surface 504 oriented to capture neutrons traveling primarily in the tool body, and which do not interact in the surrounding formation. These “axial” neutrons typically have an adverse affect on the more desirable neutron count of thermal neutrons having traveled in the formation. The monitor detector 502, and associated circuitry and processing, provides the capability of more precisely determining a count associated with axial neutrons emitted from a chemical or accelerator neutron source 510. The associated circuitry is as described above and shown in FIG. 2. Once determined, the axial neutron count is then preferably used, in part, to correct the neutron count and resulting ration provided by near 506 and far 508 neutron detectors, which are preferably as described above and shown in FIGS. 2-4.

FIG. 6 is a cross section top view of the tool portion in FIG. 5 to show the monitor detector 502. The monitor detector is preferably wrapped in a count enhancing material 600, such as a boron-loaded plastic to increase the epithermal count efficiency of the monitor detector 502.

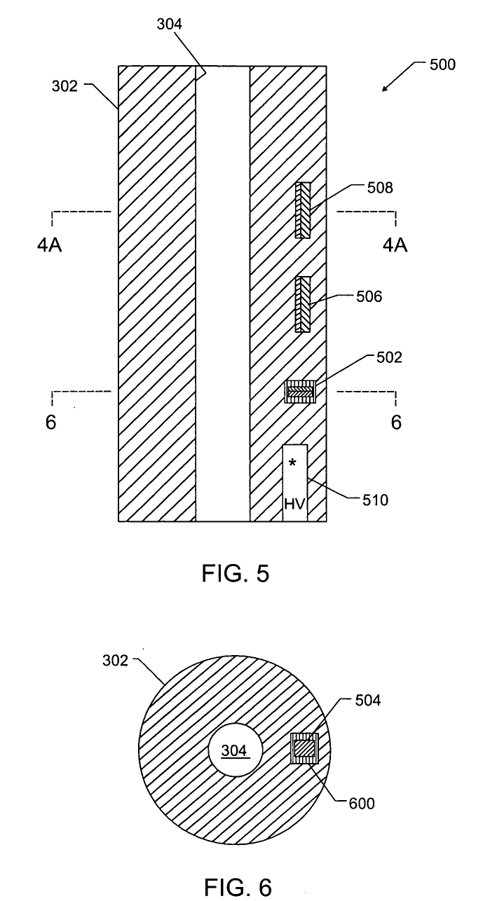

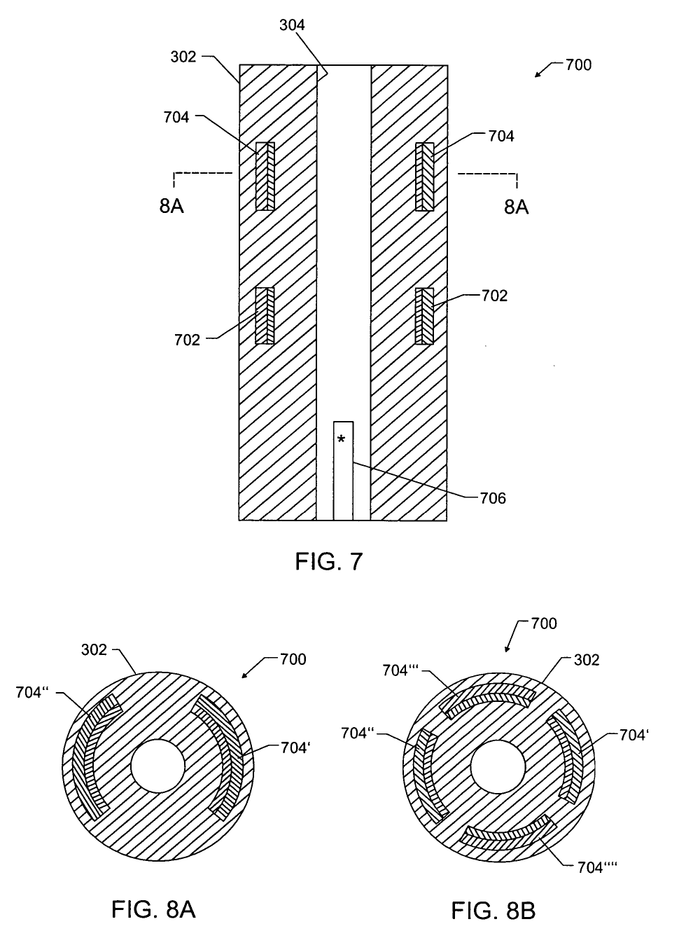

FIG. 7 is another embodiment of a tool portion 700 with curved detectors and an alternative source location. In the embodiment shown, multiple near detectors 702 and far detectors 704 are disposed in the tool body 302 to increase detection surface area. The detectors 702, 704 are disposed in the tool body 302 at a desired axial location and in a symmetrical arrangement about the central bore 302 of the tool. Each detector 702, 704 can be manufactured in various shapes to facilitate the symmetrical arrangement. The detectors can include a substantially planar detection surface, such as the surface 402 described above and shown in FIG. 4A. The detectors can include multi-planar detection surfaces such as the surfaces 402′-402′″ described above and shown in FIG. 4B, or the detectors can include a curvilinear detection surface 402 as described above and shown in FIG. 4C. In this embodiment, a chemical or accelerator neutron source 706 is preferably located in the interior of the tool at or near the center axis of the tool.

FIGS. 8A-B show alternative detector arrangements to use on the tool portion 700 shown in FIG. 7. In one preferred embodiment two detectors 704′, 704″ are disposed in the tool body substantially opposite each other at each axial detector location. Each detector has a curvilinear cross section formed in an arch shape to provide increased detection surface area. FIG. 8B shows another embodiment with four curvilinear detectors 704′, 704″, 704′″, 704′″′ disposed in the tool body and about the periphery of the body.

Other embodiments exist, which do not require further illustration. For example, the curvilinear detectors shown in FIGS. 8A-B can be replaced with planar or multi-planar detection surfaces such as the respective respective surfaces 402, 402′-402′″ described above and shown in FIGS. 4A-B. Moreover, the embodiment of FIG. 7 could also include one or more monitor detectors, such as the monitor detector 502 described above and shown in FIGS. 5-6.

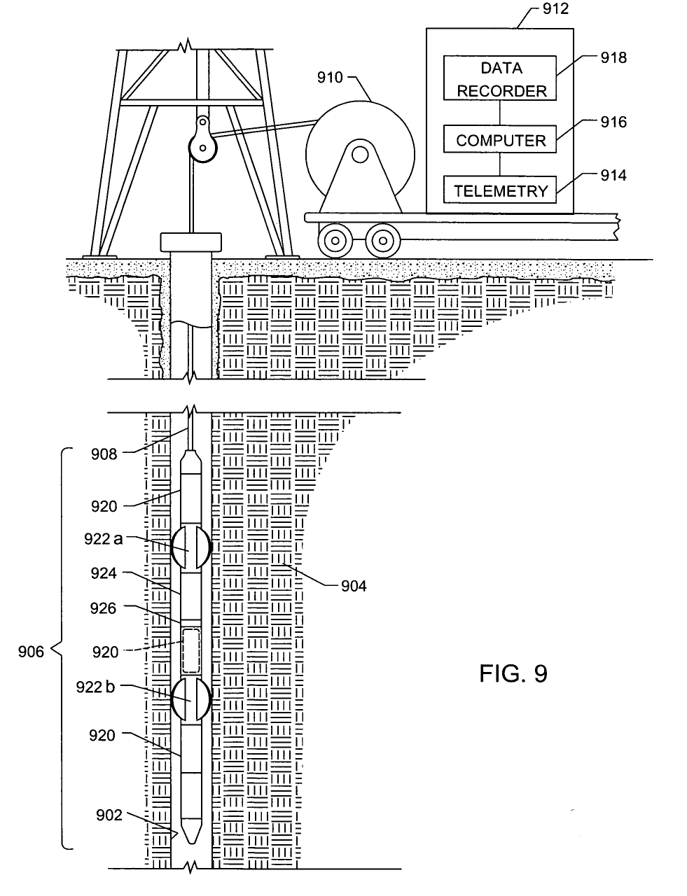

FIG. 9 shows a well logging apparatus 900 according to another embodiment of the present invention. Shown is a well logging apparatus 900 disposed in a well borehole 902 penetrating earth formations 904 for making measurements of properties of the earth formations 904. The borehole 902 is typically filled with drilling fluid to prevent formation fluid influx.

A string of logging tools 906 is lowered into the well borehole 902 by an armored electrical cable 908. The cable 908 can be spooled and unspooled from a winch or drum 910. The tool string 906 can be electrically connected to surface equipment 912 by an optical fiber (not shown separately in FIG. 9) forming part of the cable 908. The surface equipment 912 can include one part of a telemetry system 914 for communicating control signals and data to the tool string 906 and computer 916. The computer can also include a data recorder 918 for recording measurements made by the apparatus and transmitted to the surface equipment 912.

One or more logging devices 920 form part of the tool string 906. The tool string 906 is preferably centered within the well borehole 902 by a top centralizer 922a and a bottom centralizer 922b attached to the tool string 906 at axially spaced apart locations. The centralizers 922a, 922b can be of types known in the art such as bowsprings.

Circuitry for operating the logging tool 920 of the present invention is preferably located within the string 906 and within an electronics cartridge 924. The circuitry can be connected to the tool 920 through a connector 926. The tool 920 includes a neutron porosity measurement tool 928 to be described in more detail later. In general, however, the tool 928 includes a chemical or accelerator neutron source and one or more solid state neutron detectors for measuring flux resulting from emitted neutrons interacting with the formation 904. Information generated by the tool 920 is preferably carried uphole by the optical fiber (not shown in FIG. 9) of the logging cable 908.

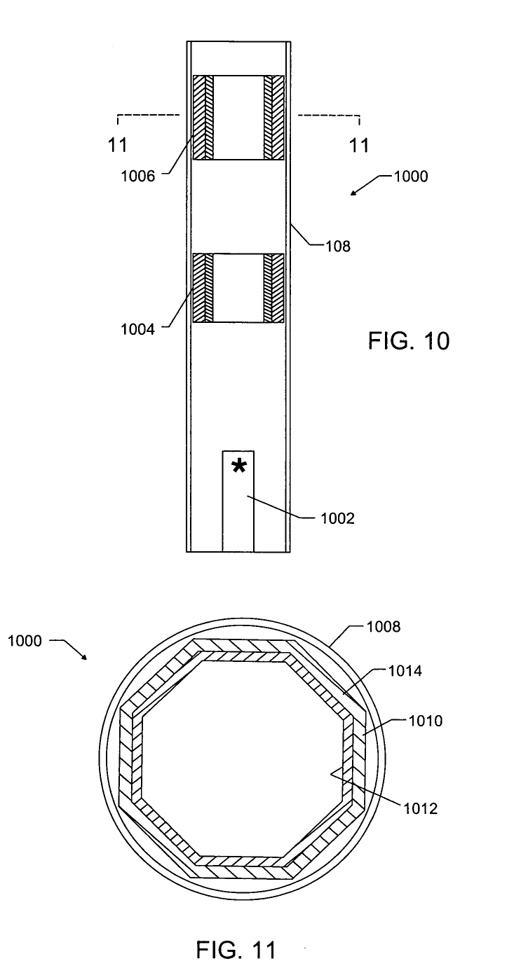

FIG. 10 is a cross section elevation view of a tool portion used in the system of FIG. 9. Shown is a tool portion 1000, which houses a chemical or accelerator neutron source 1002 and two solid state neutron detectors 1004 and 1006 according to the present invention. As discussed above, the first neutron detector functions as a near detector 1004, and the second detector functions as a far detector 1006. The source 1002 is preferably centrally located, and the detectors are preferably shaped to substantially encompass the periphery of the tool housing 1008.

FIG. 11 is a cross section top view of the tool portion of FIG. 10 to show an arrangement of the solid state detector. A sensing element 1010 as shown has an octagonal cross section. Alternatively, the sensing element 1010 might be any curvilinear or multi-planar polygon arrangement to substantially encompass the tool periphery. The sensing element 1010 includes a substrate 1012 oriented toward the tool center, while a detection surface 1014 is oriented outwardly. Other than the particular detector shape and orientation, each detector 1004 and 1006 is substantially identical in function as the detector 200 described above and shown in FIG. 2.

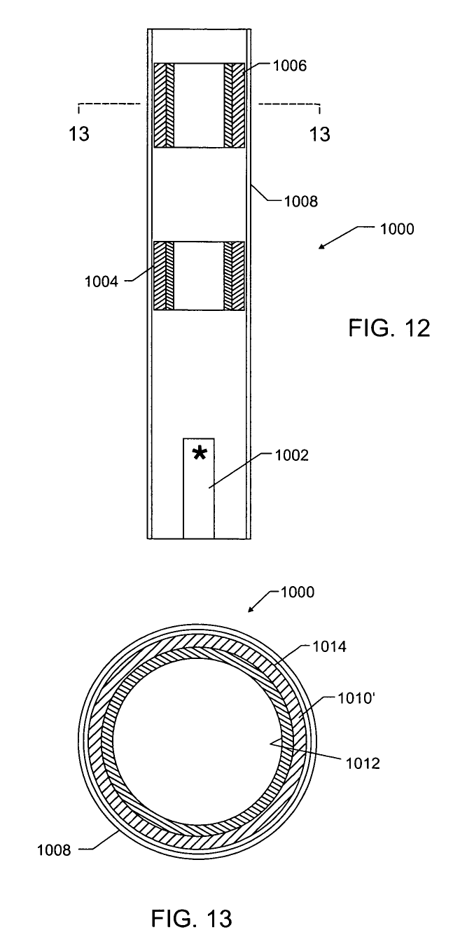

FIGS. 12 and 13 show another wireline embodiment of the present invention using a detector having a substantially circular cross section. This embodiment is similar to the embodiment of FIG. 10, but having a sensing element 1010′ shaped in a substantially circular cross section.

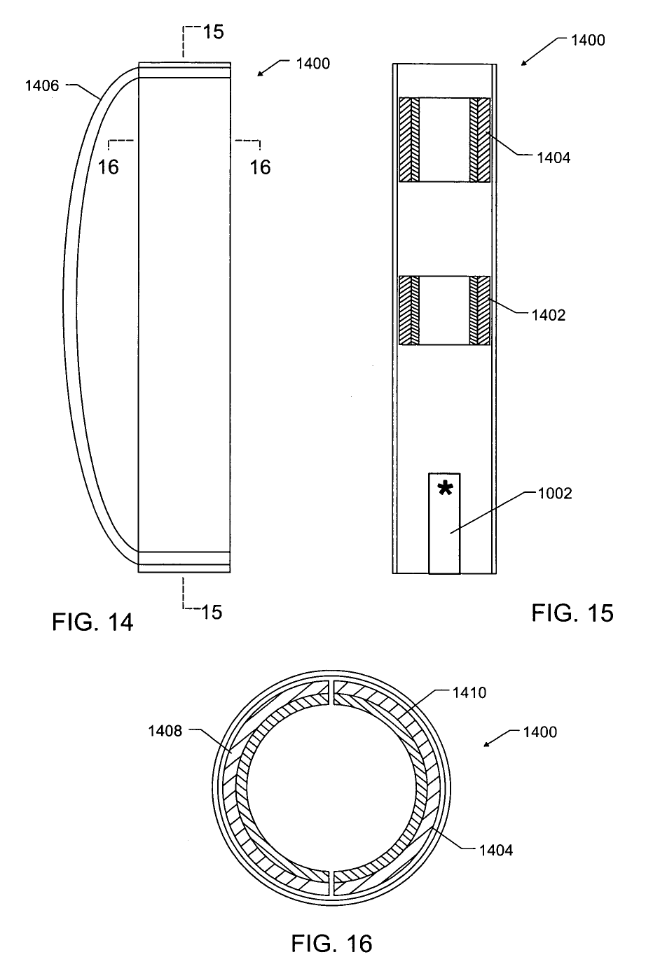

FIGS. 14-16 show another wireline embodiment of the present invention having multiple detectors 1402 and 1404 with semi-circular cross section arranged about the tool. Referring to FIG. 14, a tool portion 1400 housing neutron detectors according to the present invention might advantageously be located near a centralizer such as a known bow spring 1406. The tool portion 1400 of FIG. 14, shown in cross section in FIG. 15, includes a solid state near detector 1402 and a solid state far detector 1404, each being functionally similar to those already described in detail above. As shown in FIG. 16, the near detector and the far detector each comprise preferably two sensing elements 1408, 1410 shaped in curvilinear cross section to form C-shaped sensing elements arranged to substantially encompass the tool periphery. As shown, the sensing elements 1408, 1410 might be slightly separated to allow for two independent sensing elements, e.g. a left sensing element and a right sensing element. Counts from each element can thus be easily acquired and processed separately.

FIGS. 17A-17B show stacked and orthogonal sensor elements according to the present invention. In any embodiment of the present invention described above and shown in FIGS. 1-16, a detector can be oriented with multiple stacked sensor 1700 elements to provide both a neutron count and to operate as a calorimeter to measure neutron energy. As shown in FIG. 17B, the sensor elements 1700 might also be oriented orthogonal to other sensor elements to provide a three-dimensional neutron detector. Using these stacked and multi-axis arrangements, the present invention can be used to measure desirable parameters such as neutron porosity, epithermal and thermal neutron porosity, enhanced resolution porosity (through a combination of detectors), and azimuthal neutron porosity.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

1. An apparatus for determining a parameter of interest in an underground formation traversed by a borehole, the apparatus comprising:
(a) a work string for conveying a tool into the borehole;
(b) a neutron source coupled to the tool for irradiating the formation with neutrons; and
(c) a solid state neutron detector coupled to the tool, the solid state neutron detector having a detection surface, the detection surface being oriented for capturing neutrons emitted from the source, the captured neutrons being indicative of the parameter of interest.

2. The apparatus of claim 1, wherein the work string is selected from a group consisting of i) a wireline and ii) a drill string.

3. The apparatus of claim 1, wherein the neutron source is one of i) a chemical source and ii) an accelerator.

4. The apparatus of claim 1, wherein the detection surface forms a curved surface.

5. The apparatus of claim 1, wherein the detection surface forms one or more planar surfaces.

6. The apparatus of claim 4, wherein the curved surface includes a cross section selected from one of i) substantially circular, ii) C-shaped, and iii) arch-shaped.

7. The apparatus of claim 5, wherein one or more planar surfaces further comprise a plurality of planar surfaces oriented about a portion or more of the tool periphery.

8. The apparatus of claim 7, wherein the plurality of planar surfaces are oriented to form a polygon cross section.

9. The apparatus of claim 1, wherein the neutron detector further comprises a plurality of detectors oriented to measure flux in a plurality of directions.

10. The apparatus of claim 9, wherein the plurality of detectors comprise three detectors mounted in an orthogonal relationship for measuring flux in three dimensions.

11. The apparatus of claim 9, wherein the plurality of detectors each provide output signals, the output signals from each detector being processed separately for determining the parameter of interest.

12. The apparatus of claim 11, wherein the parameter of interest includes enhanced resolution neutron porosity.

13. The apparatus of claim 1, wherein the solid-state neutron detector is oriented to measure components of neutron flux for a predetermined orientation.

14. The apparatus of claim 1, wherein the parameter of interest includes one or more of i) neutron porosity; ii) epithermal neutron porosity; and iii) azimuthal neutron porosity.

15. The apparatus of claim 1, wherein the solid-state neutron detector comprises a plurality of detectors, at least two of the plurality of detectors being oriented in a stacked relationship.

16. The apparatus of claim 6 further comprising a circuit for processing an output of the at least two stacked detectors, the processed output being indicative of at least one of i) neutron count and ii) neutron energy.

17. The apparatus of claim 1, wherein the solid state neutron detector further comprises at least one first detector disposed on the tool axially spaced from the neutron source and at least one second detector axially spaced from the first detector, the second detector being axially farther from the source than the first detector.

18. The apparatus of claim 1, wherein the solid state neutron detector is coupled to a selectively extendable member, the selectively extendable member being selectively extendable from the work string to move the solid state neutron detector toward the borehole wall.

19. The apparatus of claim 1, wherein the work string comprises a drill string and a non-rotating sleeve, the solid state neutron detector being mounted on the non-rotating sleeve.

20. The apparatus of claim 1, wherein the work string comprises a drill string and a stabilizer blade, the solid state neutron detector being mounted on the stabilizer blade.

21. The apparatus of claim 18, wherein the extendable element includes one of i) and extendable probe and ii) and extendable steering rib.

22. The apparatus of claim 1, wherein the solid state neutron detector comprises a plurality of solid state neutron detectors, at least one of the plurality of solid state neutron detectors being disposed proximate the neutron source and oriented for monitoring the neutrons emitted from the neutron source.

23. An apparatus for detecting a formation parameter of interest, the apparatus comprising:
(a) a tool conveyable through a borehole;
(b) a neutron source coupled to the tool for irradiating the formation with neutrons; and
(c) a solid-state neutron detector coupled to the tool, the solid state neutron detector having a non-planar surface adapted to capture neutrons returning from the formation.

24. The apparatus of claim 23, wherein the non-planar surface includes a curved surface.

25. The apparatus of claim 23, wherein the non-planar surface includes a plurality of planar surfaces angularly displaced to form the non-planar surface.

26. The apparatus of claim 23, wherein the solid state neutron detector further comprises a plurality of solid state neutron detectors arranged about a periphery of the tool.

27. The apparatus of claim 23, wherein in the detection surface includes a deposit of boron carbide.

28. The apparatus of claim 23, wherein the detector comprises a plurality of detectors longitudinally spaced apart.

29. The apparatus of claim 23, wherein the source is one of (i) a chemical neutron source, and (ii) a neutron accelerator.

30. The apparatus of claim 23, wherein the at least one detector includes two or more C-shaped detectors.

31. The apparatus of claim 30, wherein the two or more C-shaped detectors enclose substantially an entire periphery of the tool.

32. The apparatus of claim 23 further comprising an electronic circuit coupled to the detector for providing current pulse responsive to neutrons captured by the detector.

33. The apparatus of claim 32 further comprising a processing circuit for processing the current pulse and determining a parameter of interest in response thereto.

34. The apparatus of claim 33, wherein the parameter of interest includes one or more of i) neutron porosity; ii) epithermal neutron porosity; iii) azimuthal neutron porosity; and iv)neutron energy.

35. The apparatus of claim 23 further comprising at least one secondary detector for absorbing neutrons traveling along a longitudinal direction of the tool.

36. The apparatus of claim 23, wherein the at least one detector is disposed on a member extended from the tool body.

37. The apparatus of claim 36, wherein the extended member is one of i) a fixed stabilizer blade; ii) an extendable steering rib; and iii) an extendable probe.

38. A method of testing an underground formation comprising:
(a) conveying a tool through a well borehole traversing the formation;
(b) irradiating the formation with neutrons using a neutron source;
(c) detecting neutrons refracted from the formation using a solid-state neutron detector, the detector having a detection surface oriented to receive neutrons emitted from the source; and
(d) determining a parameter of interest based at least in part on the received neutrons.

39. The method of claim 38, wherein the tool is conveyed on one of i) a wireline and ii) a drill string.

40. The method of claim 38, wherein the neutrons are emitted from a source selected from one of i) a chemical source and ii) an accelerator.

41. The method of claim 38, wherein the detection surface forms a curved surface.

42. The method of claim 38, wherein the detection surface forms one or more planar surfaces.

43. The method of claim 41, wherein the curved surface includes a cross section selected from one of i) substantially circular, ii) C-shaped, and iii) arch-shaped.

44. The method of claim 42, wherein one or more planar surfaces further comprise a plurality of planar surfaces the method further comprising orienting the plurality of planar surfaces about a portion or more of the tool periphery.

45. The method of claim 38, wherein the neutron detector further comprises a plurality of detectors the method further comprising orienting the plurality of detectors to measure flux in a plurality of directions.

46. The method of claim 45 further comprising measuring flux in three dimensions.

47. The method of claim 45 further comprising providing output signals from each of the plurality of detectors and processing each output signal separately for determining the parameter of interest.

48. The method of claim 38, wherein the solid-state neutron detector is oriented to measure components of neutron flux for a predetermined orientation.

49. The method of claim 38, wherein the parameter of interest includes one or more of i) neutron porosity; ii) epithermal neutron porosity; and iii) azimuthal neutron porosity.

50. The method of claim 38 further comprising orienting at least two solid state neutron detectors in a stacked relationship.

51. The method of claim 50 further comprising processing an output of the stacked detectors to determine one of i) neutron count and ii) neutron energy.

52. The method of claim 38, wherein the solid state neutron detector is mounted on a selectively extendable member, the method further comprising moving the solid state neutron detector toward the borehole wall using the selectively extendable member.

53. The method of claim 38, the tool is mounted disposed on a non-rotating sleeve, the non-rotating sleeve being mounted on a drill string, the method further comprising operating the tool during drilling of the borehole.

54. The method of claim 38, wherein the solid state neutron detector comprises a plurality of solid state neutron detectors, at least one of the plurality of solid state neutron detectors being disposed proximate the neutron source, the method further comprising monitoring the neutrons emitted from the neutron source using the proximately disposed solid state neutron detector.
